(19) United States
(12) Patent Application Publication
(10) Pub. No.: US 2025/0036506 A1
(43) Pub. Date: Jan. 30, 2025

(54) SYSTEM AND METHOD OF USING ADVANCED COMPUTATION MODELS FOR DATA ANALYSIS AND AUTOMATED DECISION-MAKING FOR ROOT CAUSE ANALYSIS WITHIN SOFTWARE

(71) Applicant: BANK OF AMERICA CORPORATION, Charlotte, NC (US)

(72) Inventors: Brian Neal Jacobson, Los Angeles, CA (US); Amer Ali, Jersey City, NJ (US); Erik Dahl, Newark, DE (US); Pratap Dande, Saint Johns, FL (US); Elvis Nyamwange, Little Elm, TX (US); Rahul Shashidhar Phadnis, Charlotte, NC (US); Sailesh Vezzu, Hillsborough, NJ (US); Hari Vuppala, Charlotte, NC (US); Rahul Yaksh, Austin, TX (US)

(73) Assignee: BANK OF AMERICA CORPORATION, Charlotte, NC (US)

(21) Appl. No.: 18/227,759

(22) Filed: Jul. 28, 2023

(51) Int. Cl. G06F 11/07; G06F 11/36

(52) U.S. Cl. CPC G06F 11/079; G06F 11/3676

(57) ABSTRACT

Systems, computer program products, and methods are described herein for using advanced computation models for data analysis and automated decision-making for root cause analysis within software. The present disclosure is configured to receive a set of file extensions associated with an error generated from an at least one piece of software; analyzing the set of file extensions using an advanced computation model for data analysis and automated decision-making; determining a set of root cause analysis from the analyzed set of file extensions using a root cause database; summarizing the set of root cause analysis using the advanced computation model for data analysis and automated decision making and a predetermined database of identifiers; and transmitting the summarized set of root cause analysis associated with the error generated from the at least one piece of software to an end-point device.

### TECHNOLOGICAL FIELD

Example embodiments of the present disclosure relate to systems and methods of using advanced computation models for data analysis and automated decision-making for root cause analysis within software.

### BACKGROUND

Operations and site reliability engineering teams may not possess the capability or skill set to identify and solve errors during software development. Increasing amounts of time and resources may be expended to solve said errors, as software development may proceed in a non-linear fashion.

Applicant has identified a number of deficiencies and problems associated with the use of advanced computation models for data analysis and automated decision-making for root cause analysis within software. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for using advanced computation models for data analysis and automated decision-making for root cause analysis within software.

In one aspect, a system for using advanced computation models for data analysis and automated decision-making for root cause analysis within software is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: receive a set of file extensions associated with an error generated from an at least one piece of software, wherein the set of file extensions includes a record of events and actions from the at least one piece of software; analyze the set of file extensions using an advanced computation model for data analysis and automated decision-making; determine a set of root cause analysis from the analyzed set of file extensions using a root cause database, wherein the root cause database is comprised of previously encountered file extensions and associated root cause analyses; summarize the set of root cause analysis using the advanced computation model for data analysis and automated decision-making and a predetermined database of identifiers; and transmit the summarized set of root cause analysis associated with the error generated from the at least one piece of software to an end-point device.

In some embodiments, analysis of the set of file extensions using advanced computation models for data analysis and automated decision-making comprises searching a secondary set of file extensions associated with the generated error.

In some embodiments, wherein summarizing the set of root cause analysis using the advanced computation model for data analysis and automated decision-making and a predetermined database of identifiers comprises forming the summary of the set of root cause analysis using terms found within the database of identifiers.

In some embodiments, wherein determination of the root cause analysis includes: transfer the set of file extensions to an external source; determine the set of root cause analysis using the external source; and store the set of root cause analysis and associated set of file extensions within the root cause database.

In some embodiments, wherein transmission of the summarized set of root cause analysis associated with the error generated from the at least one piece of software comprises: a notification identifying a root cause location within the at least one piece of software associated with the error generated within the at least one piece of software; a notification defining the error generated within the at least one piece of software; and a notification identifying the set of file extensions associated with the error generated from the at least one piece of software.

In some embodiments, wherein the set of root cause analysis transmitted to the end-point device comprises: a summary of a root cause of the error; and a location of the error identified on the at least one piece of software.

In some embodiments, wherein transmission of the summarized set of root cause analysis associated with the error generated from the at least one piece of software further comprises an input transmitted to the end-point device associated with the set of root cause analysis.

In another aspect, a computer program product for using advanced computation models for data analysis and automated decision-making for root cause analysis within software, the computer program product comprising at least one non-transitory computer-readable medium having computer-readable program code portions embodied therein, the computer-readable program code portions including: an executable portion configured to receive a set of file extensions associated with an error generated from an at least one piece of software, wherein the set of file extensions comprises a record of events and actions from the at least one piece of software; an executable portion configured to analyze the set of file extensions using an advanced computation model for data analysis and automated decision-making; an executable portion configured to determine a set of root cause analysis from the analyzed set of file extensions using a root cause database, wherein the root cause database is comprised of previously encountered file extensions and associated root cause analyses; an executable portion configured to summarize the set of root cause analysis using the advanced computation model for data analysis and automated decision-making and a predetermined database of identifiers; and an executable portion configured to transmit the summarized set of root cause analysis associated with the error generated from the at least one piece of software to the end-point device.

In some embodiments, analysis of the set of file extensions using advanced computation models for data analysis and automated decision-making comprises searching a secondary set of file extensions associated with the generated error.

In some embodiments, wherein summarizing the set of root cause analysis using the advanced computation model for data analysis and automated decision-making and a predetermined database of identifiers comprises forming the summary of the set of root cause analysis using terms found within the database of identifiers.

In some embodiments, wherein determination of the root cause analysis includes: transfer the set of file extensions to an external source; determine the set of root cause analysis using the external source; and store the set of root cause analysis and associated set of file extensions within the root cause database.

In some embodiments, transmission of the summarized set of root cause analysis associated with the error generated from the at least one piece of software comprises: a notification identifying a root cause location within the at least one piece of software associated with the error generated within the at least one piece of software; a notification defining the error generated within the at least one piece of software; and a notification identifying the set of file extensions associated with the error generated from the at least one piece of software.

In some embodiments, wherein the set of root cause analysis transmitted to the end-point device comprises: a summary of a root cause of the error; and a location of the error identified on the at least one piece of software.

In some embodiments, wherein transmission of the summarized set of root cause analysis associated with the error generated from the at least one piece of software further comprises an input transmitted to the end-point device associated with the set of root cause analysis.

In another aspect, a method for using advanced computation models for data analysis and automated decision-making for root cause analysis within software, the method comprising: receiving a set of file extensions associated with an error generated from an at least one piece of software, wherein the set of file extensions comprises a record of events and actions from the at least one piece of software; analyzing the set of file extensions using an advanced computation model for data analysis and automated decision-making; determining a set of root cause analysis from the analyzed set of file extensions using a root cause database, wherein the root cause database is comprised of previously encountered file extensions and associated root cause analyses; summarizing the set of root cause analysis using the advanced computation model for data analysis and automated decision-making and a predetermined database of identifiers; and transmitting the summarized set of root cause analysis associated with the error generated from the at least one piece of software to the end-point device.

In some embodiments, analyzing the set of file extensions using advanced computation models for data analysis and automated decision-making comprises searching a secondary set of file extensions associated with the generated error.

In some embodiments, summarizing the set of root cause analysis using the advanced computation model for data analysis and automated decision-making and a predetermined database of identifiers comprises forming the summary of the set of root cause analysis using terms found within the database of identifiers.

In some embodiments, determining of the root cause analysis comprises: transferring the set of file extensions to an external source; determining the root cause analysis using the external source; and storing the root cause analysis and associated set of file extensions within the root cause database.

In some embodiments, transmitting the summarized set of root cause analysis associated with the error generated from the at least one piece of software comprises: a notification identifying a root cause location within the at least one piece of software associated with the error generated within the at least one piece of software; a notification defining the error generated within the at least one piece of software; and a notification identifying the set of file extensions associated with the error generated from the at least one piece of software.

In some embodiments, transmitting the summarized set of root cause analysis associated with the error generated from the at least on piece of software further comprises an input transmitted to the end-point device associated with the set of root cause analysis.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for systems and methods using advanced computation models for data analysis and automated decision-making for root cause analysis within software in accordance with an embodiment of the disclosure;

FIG. 2 illustrates an exemplary machine learning (ML) subsystem architecture, in accordance with an embodiment of the disclosure;

FIG. 3 illustrates a process flow for using advanced computation models for data analysis and automated decision making for root cause analysis within software, in accordance with an embodiment of the disclosure; and

FIG. 4 illustrates an exemplary root cause analysis and transmission process, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As described herein, “machine learning” or “artificial intelligence” may be referred to as an advanced computational model for data analysis and automated decision making. Machine learning may be used throughout the root cause detection and analysis, as described in greater detail below

The development of software may progress in a non-linear fashion, and errors encountered during software development may be difficult to address, fix, and/or solve to individuals without prior knowledge of the software. Errors addressed or discovered by users, individuals, and/or entities unfamiliar with software development may further be embedded within multiple pieces of software, further exacerbating errors and difficulties encountered through the creation of technical errors.

Individuals, users, or entities tasked with addressing and solving errors within software may not possess the technical knowledge or ability to diagnose an error encountered within said software. The inability of said individuals, users, or entities to address and solve errors may cause delays, difficulties, and the expenditure of further resources to determine the root cause of the error. In other instances, outside resources may be used to diagnose and determine the error, further incurring delays and the use of resources.

The use of machine learning may be used to diagnose and describe errors encountered within software through the recognition of patterns, pathways, and deviations from past procedures. Machine learning, or advanced computation models for data analysis and automated decision-making, expediates the root cause analysis process as well as describes the encountered error to individuals or entities with less experience in software development. An error found within the software as well as file extensions with information associated with the encountered error may be received by the machine learning subsystem from an end user. The machine learning subsystem may then be able to identify and diagnose the error using the file extensions provided, as well as provide a summary using identifiers, i.e., terms/language that can be understood with minimal levels of software development. The explanation/summarized set of root causes analysis may then be transmitted to the end-user, which may then use the root cause analysis to address the error.

Accordingly, the present disclosure comprises receiving a set of file extensions (such as log files) associated with an error within software. The set of file extensions denote actions, events, commands, categories, and other information related to the encountered error. A form of machine learning (i.e., the advanced computation model for data analysis and automated-decision-making) may receive the set of file extensions, and analyze said set of file extensions to determine the root cause of the encountered error within the software. The form of machine learning may be used to recognize patterns, pathways, and deviations of the received set of file extensions when compared against previously encountered sets of file extensions and the subsequent root cause analyses. The previously encountered sets of file extensions and the root cause analyses produced may be stored within a root cause database, enabling the machine learning to increase its ability to recognize received errors and produce root cause analyses with greater accuracy. The machine learning may further collect/receive file extensions determined to be associated with the error and provide a root cause analysis. The root cause analysis may identify the root cause of the error and explain the root cause error in language understandable to individuals, groups, or entities with surface level experience in addressing errors in software (i.e., the root cause may be explained to enable individuals without a technical background to understand the error).

What is more, the present disclosure provides a technical solution to a technical problem. As described herein, the technical problem includes identification and diagnosis of root causes of errors within a plurality of software among individuals, entities, and/or groups with entry level experience in software development. The technical solution presented herein allows for identification and determination of the root cause using machine learning and associated file extensions to recognize the root cause error, diagnose the root cause, and explain the root cause error using nomenclature understood by groups with entry level experience in software development. In particular, using advanced computation models for data analysis and automated decision-making for root cause analysis is an improvement over existing solutions to the identification and diagnosis of root causes of errors within a plurality of software among individuals, entities, and/or groups with entry level experience in software development, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

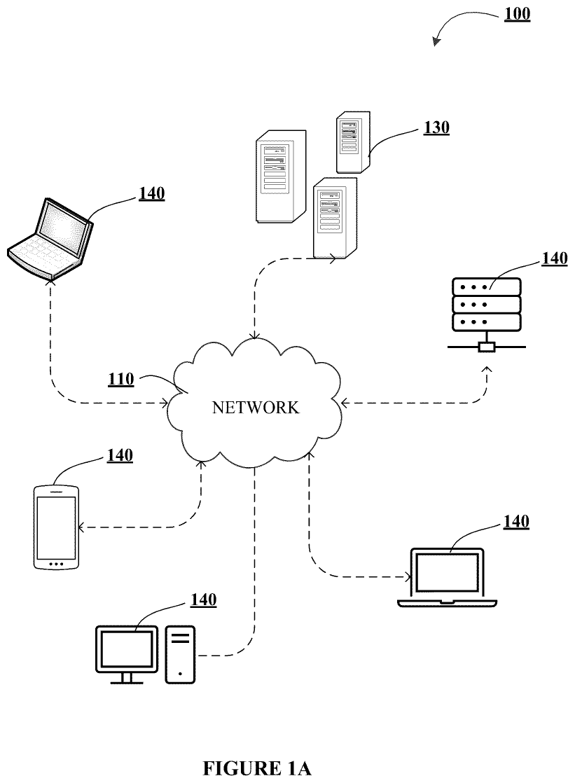

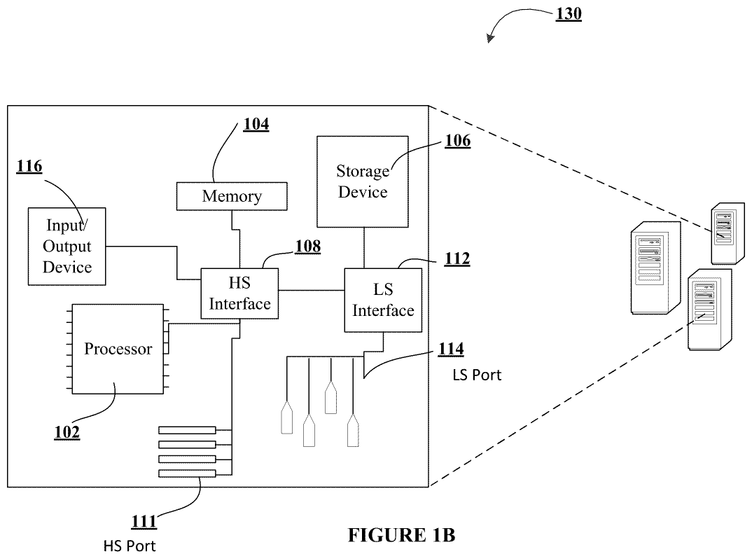

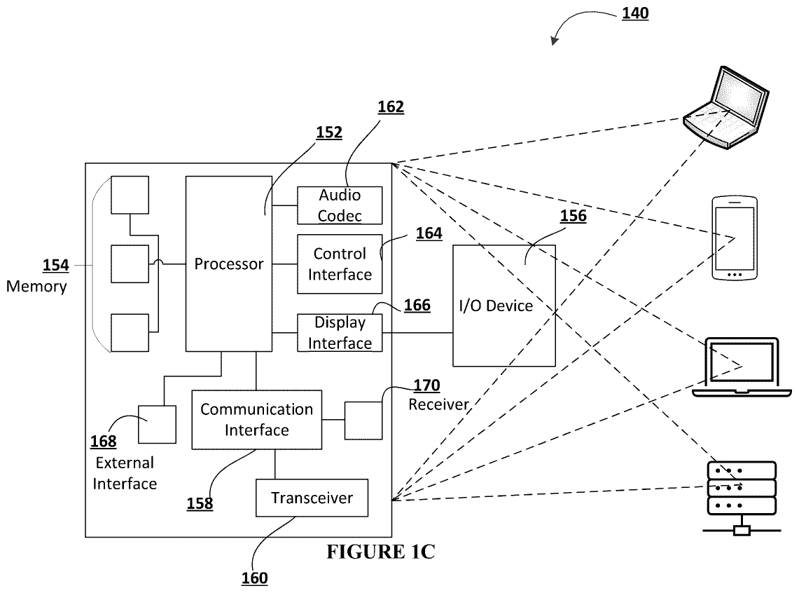

FIGS. 1A-1C illustrate technical components of an exemplary distributed computing environment for systems and methods of using advanced computation models for data analysis and automated decision-making for root cause analysis within software 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

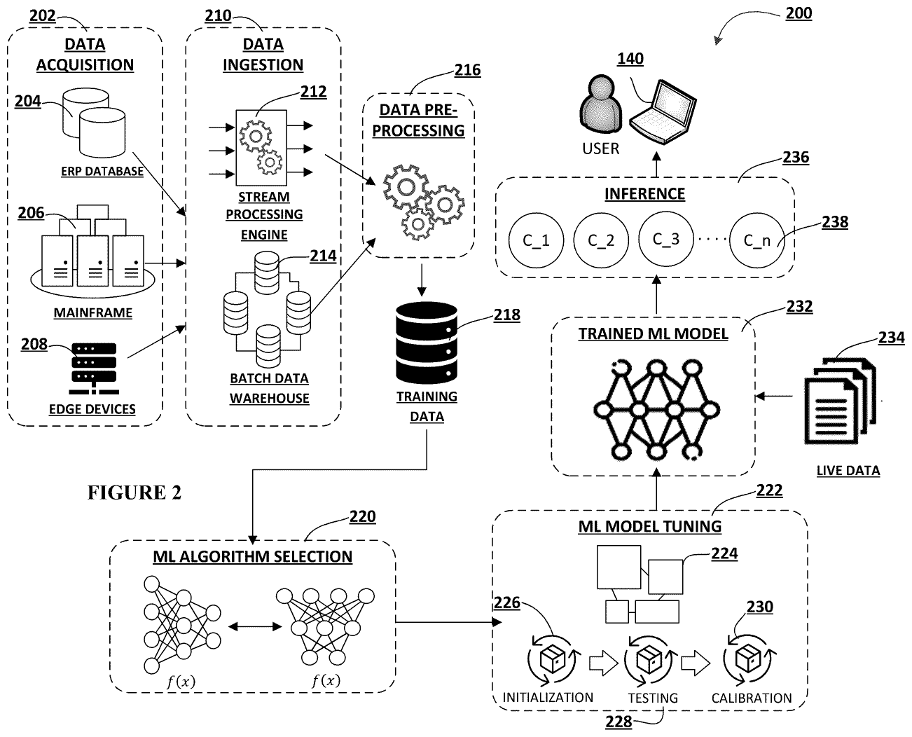

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

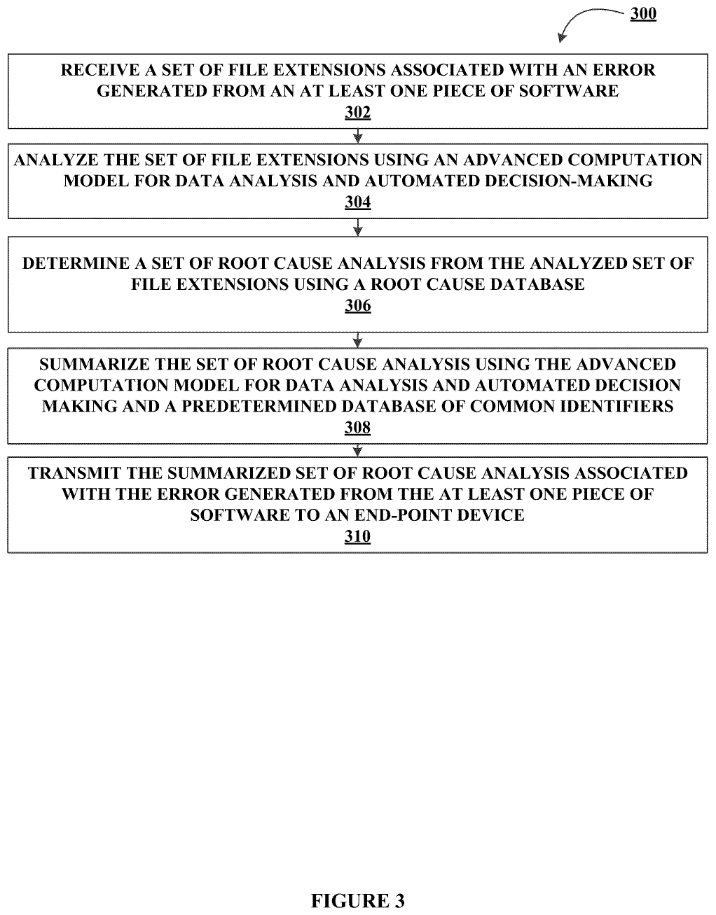

FIG. 3 illustrates a process flow 300 for systems and methods of using advanced computation models for data analysis and automated decision-making for root cause analysis within software. In some embodiments, a system and method of using advanced computation models for data analysis and automated decision-making for root cause analysis within software (e.g., similar to the one or more of the systems described herein with respect to FIGS. 1A-1C, 2, and FIG. 4) may perform one or more of the steps of process flow 300.

As shown in Block 302, the process flow 300 may include the step of receiving a set of file extensions associated with an error generated from an at least one piece of software. The set of file extensions may be comprised of a record of events and actions from said software. The set of file extensions may be comprised of a plurality of log files, records, messages, timestamps, event descriptions, error messages, system or application metrics, configuration changes, sets of information, sets of data, and the like associated with the error generated from the at least one piece of software. For instance, the set of file extensions may be a set of log files associated with an error resulting from a plurality of software. The set of file extensions may include an error code, a time in which the error occurred, software/hardware associated with the error, code associated with the error, inputs associated with the error, commands associated with the error, a set of actions preceding the error, and the like.

In some embodiments, the set of file extensions may be received and/or accessed through permitted access to a set of information associated with the at least one piece of software. For instance, the advanced computation model for data analysis and automated decision making may be given access to search through a predetermined set of data, database, set of files, or the like to add or determine if further file extensions may aid in determining the root cause of the error. In other words, an extended set of data/information may be available to machine learning to analyze and use in the determination of root cause analysis based on the amount of access given to the machine learning subsystem.

In some embodiments, the set of file extensions may comprise an overarching identifier that classifies types of file extensions within the set of file extensions. The overarching identifier may be used to sort, identify, group, and/or manipulate file extensions within the set of file extensions. The set of file extensions may be used to further identify trends or similar groups associated with an error and further increase the accuracy of the identification of the root cause within the at least one piece of software.

In some embodiments, the at least one piece of software generating the error may be comprised of a plurality of software and/or overlapping software. For instance, the error may be generated from software given conflicting instructions, which may cause the error to be transmitted from the overlapping software involved in the conflicting software. The errors received from the overlapping software may be combined into one error. In another instance, a plurality of errors may be received, each error comprising a respective set of file extensions associated with the error generated. Each error and associated set of file extensions may be subjected to the subsequent analysis, determination of root cause, summarization, and transmission as described in greater detail below.

In some embodiments, the generated error from an end user may be comprised of an error within an application, service, platform, code and/or the like. The error may be comprised of a defect or “bug” within the at least one piece of software, said error may be related to functional, logical, workflow, unit level, system level, out of bounds, and security errors/defects/issues. The types of error generated from the end user may not be constrained to the previously listed types of errors and may further be received with the associated set of file extensions.

As shown in Block 304, the process flow 300 may include the step of analyzing the set of file extensions using an advanced computation model for data analysis and automated decision making. Analysis of the set of file extensions may comprise using the received set of file extensions as live data 234 and/or training data 218 as seen in FIG. 2. The advanced computation model for data analysis and automated decision making may be represented at least partially by the machine learning subsystem 200 as seen in FIG. 2. The live data may be used by the machine learning subsystem 200, which may further enable analysis of the set of file extensions.

In some embodiments, analyzing the set of file extensions may comprise conducting an additional analysis of the files received to find a secondary set of file extensions associated with the generated error. An expanded search of the secondary set of extension files associated with the generated error may be conducted by the advanced computation model for data analysis and automated decision-making (i.e., the machine learning subsystem described in FIG. 2). In other words, the advanced computation model for data analysis and automated decision making may receive an initial set of file extensions associated with the error and search for a secondary set of file extensions it may determine to be associated with the generated error. For instance, an error generated from the software and the associated file extensions may include an error describing a connection issue. The received error may not state the connection error is generated from an out-of-date decryption certificate. The advanced computation model for data analysis and automated decision making may have been trained to recognize and/or identify errors associated with the connection issue and check to ensure the decryption certificate is up to date. The advanced computation model for data analysis and automated decision making may then perform a search to obtain a secondary set of file extensions associated with the generated error. The secondary search may enable the advanced computation model for data analysis and automated decision making to determine the root cause associated with the error.

As shown in Block 306, the process flow 300 may include the step of determining a set of root cause analysis from the analyzed set of file extensions using a root cause database. The root cause database may be comprised of previously encountered file extensions and associated root cause analyses. Determination of the root cause analysis may be comprised of the point of origin of the error, the items, aspects, and/or code that may be causing the error, and/or the primary source of the error. The root cause database may be comprised of previously encountered file extensions and determined root cause analyses. The root cause database may be used to determine the root cause analysis through comparison of the received set of file extensions with the set of file extensions within the root cause database, which may then determine the root cause of the error generated from the at least one piece of software.

In some embodiments, the set of root cause analysis may be determined through comparison of the set of file extensions and generated error with file extensions within the root cause database. Comparisons may enable the advanced computation model for data analysis and automated decision-making to determine alterations, changes, interruptions, and/or irregularities, between the received file extensions and the file extensions within the root cause database. The differences found from these comparisons may enable the advanced computation model for data analysis and automated decision-making to determine the root cause associated with the error. For example, an error concerning an “invalid connection” and its associated file extensions may be compared to the root cause database. The comparison may determine the root cause to be an invalid decryption certificate as the root cause of the invalid connection. The root cause analysis may provide a diagnosis of the source of the error beyond the original stated error (i.e., the root cause analysis provides insight into why there is a connection error as opposed to merely stating that there is a connection error).

In some embodiments, determination of the set of root cause analysis may comprise transferring the set of file extensions to an external source. Transfer of the set of file extensions to the external source may occur in instances where the advanced computation model for data analysis and automated-decision making is unable to determine the root cause of the error, incorrectly determines the root cause of the error, and/or encounters a previously unencountered type of error. The external source may be comprised of an individual, entity, group, and/or database that may be able to determine the root cause of the error and provide the root cause analysis associated with the error. Upon determination of the root cause analysis, the set of file extensions, the root cause analysis, and the error may be used as training data 218 as seen in FIG. 2. Root cause analyses determined by the external source and the associated set of file extensions may be stored within the root cause database.

As shown in Block 308, the process flow 300 may include the step of summarizing the set of root cause analysis using the advanced computation model for data analysis and automated decision making and a predetermined database of identifiers. Summarization of the set of root cause analysis may be comprised of changing, interpreting, expressing, converting, and/or translating the set of root cause analysis into a format defined through the predetermined database of identifiers. The predetermined database of identifiers may be used as a reference to summarize the set of root cause analysis into a format understood by individuals without a technical background associated with the at least one piece of software. In other words, summarization of the set of root cause analysis explains the root cause analysis received in a format understood by end-users with less experience in addressing and evaluating errors encountered within the at least one piece of software. The summary of the root cause may enable the error to be explained through non-technical nomenclature found within the predetermined database of identifiers. The predetermined database of identifiers may be updated as additional root causes are examined.

In some embodiments, the set of root cause analysis may be comprised of a summary of a root cause associated with the error, and a location of the error identified on the at least on piece of software. For instance, the root cause of the error may be determined through comparison of the set of file extensions and error with file extensions and errors previously encountered within the root cause database. In one example, the error may be a failure to retrieve a set of data with no explanation of why the set of data cannot be retrieved. In this example, the root cause analysis may compare the error to previously encountered errors. Such comparisons may show for instance, that a specific cluster of servers may be identified as comprising an out-of-date code base that fails to retrieve the set of data. The comparison to the root cause database enables the location of the error to be identified as well as a summary of a root cause of the error. The root cause analysis may comprise the summary of the root cause of the error and a location of the error identified on the at least one piece of software.

In some embodiments, the predetermined database of identifiers may be used to summarize the root cause analysis of the generated error into terms within said database. For instance, an error received indicating an inability to communicate may be analyzed to determine the decryption certificate is invalid. The summarized or rephrased error may indicate the invalid decryption certificate, how it should be updated, and the areas/code/portions of the at least one piece of software which may be affected by the updated decryption certificate. Another example may be

As shown in Block 310, the process flow 300 may include the step of transmitting the summarized set of root cause analysis associated with the error generated from the at least one piece of software to an end-point device. Transmission of the summarized set of root cause analysis to the end-point device may comprise transmission of a notification, alert, and/or message to the end-point device identifying the root cause of the error and an analysis of the root cause. The analysis of the root cause may be stated in a language and/or format enabling an individual to comprehend the source of the error as well as the location of the error within the at least one piece of software. Transmission of the summarized set of root cause analysis associated with the error generated from the at least on piece of software may be comprised of a notification identifying a location within the at least one piece of software indicating where the error generated from the at least one piece of software has occurred, a notification defining the error generated from the at least one piece of software, and a notification identifying the set of file extensions associated with the error generated from the at least one piece of software.

In some embodiments, transmission of the summarized set of root cause analysis associated with the error generated from the at least one piece of software further comprises an input transmitted to the end-point device associated with the root cause analysis. The input transmitted to the end-point device may be a questionnaire, survey, feedback input, forum, assessment, grade, or the like to gain input on the summarized set of root cause analysis. For instance, the transmission may include an input wherein the accuracy of the root cause analysis can be rated. For example, a summarized root cause analysis may include an input on the accuracy of the root cause analysis and/or an input on the comprehensibility of the summary of the root cause analysis. In other words, the input transmitted to the end-point device may be a way to obtain feedback on the root cause analysis accuracy and language. Input may further be used to adjust the root cause analysis process accordingly.

In some embodiments, the input transmitted to the end-point device may comprise an option to contact an external source. The external source may be contacted to begin transferring the set of file extensions, and subsequently use the external source to determine the root cause analysis. In other words, if the root cause analysis is inaccurate, the input may be used to contact and use the external source to determine the root cause analysis.

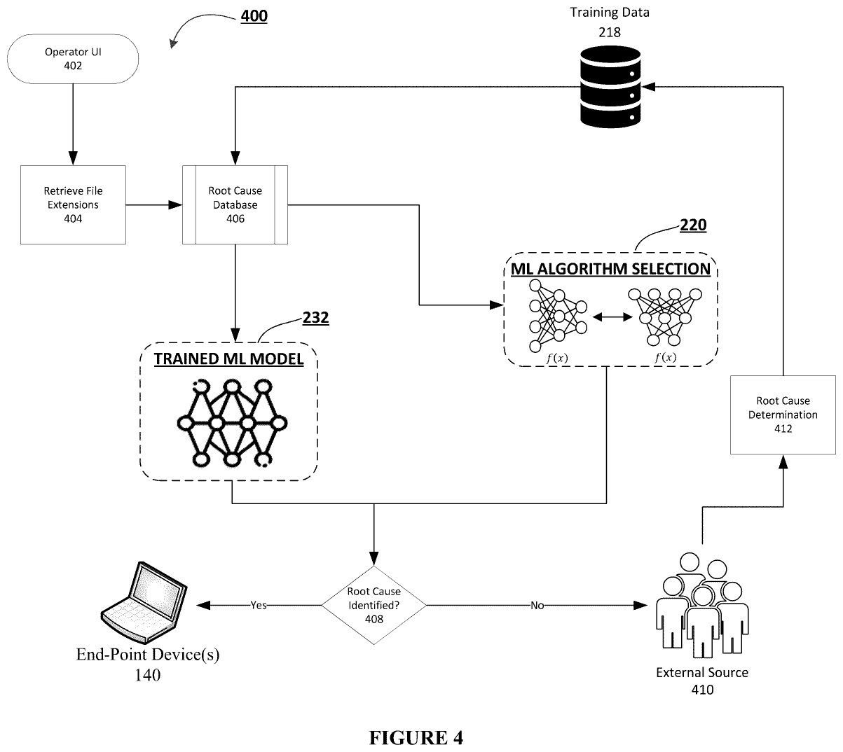

FIG. 4 illustrates an exemplary root cause analysis and transmission process in accordance with an embodiment of the disclosure. As such, unless otherwise stated, the exemplary root cause analysis and transmission process (e.g., similar to one or more of the systems described with respect to FIGS. 1A-1C, 2, and 3) may perform one or more of the functions described. The root cause analysis and transmission subsystem 400 may be comprised of an operator user interface (operator UI) 402, retrieval of logs 404, a root cause database 406, parts of the machine learning subsystem architecture 200 (including but not limited to the training data 218, ML algorithm selection 220, and the trained ML model 232), an end-point device(s) 140, and an external source 410.

The operator UI 402 may be the interface where the error and associated set of file extensions are received. The operator UI 402 may receive said error and set of file extensions through manual and/or automatic input of the error and set of file extensions upon generation/creation/discovery of the error. Retrieval of file extensions 404 may then be conducted, wherein retrieval may be comprised of a secondary set of file extensions associated with the generated error. The secondary set of file extensions may be gathered through the machine learning subsystem architecture 200. The set of file extensions as well as the error maybe stored within the root cause database 406. The root cause database 406 may be comprised of previously encountered file extensions, root cause analyses, and previously encountered errors. Upon storage, the set of file extensions may be used as live data 234 within the trained ML model 232 as part of the machine learning subsystem architecture 200. The machine learning may be used to analyze the set of file extensions and subsequently determine a root cause analysis associated with the error. Determination of the root cause analysis may then be summarized using the predetermined database of identifiers to explain the root cause analysis using language/nomenclature. If the root cause analysis determines the root cause, a transmission may be sent to the end-point device(s) 140. If the root cause analysis was unable to determine the root cause, the set of file extensions as well as the error may be transmitted to an external source 410. The external source 410 may be comprised of individuals, groups, entities (i.e., a development team) which may be able to determine the root cause associated with the error and set of file extensions. The root cause determination 412 may then be used as training data 218, which may then be stored in the root cause database 406, and subsequently used to train the machine learning subsystem architecture 200.

It will be understood that the embodiment of the exemplary root cause analysis and transmission process 400 illustrated in FIG. 4 may vary, and that the number of elements within the exemplary root cause analysis and transmission process may include more, fewer, or different components.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for using advanced computation models for data analysis and automated decision-making for root cause analysis within software, the system comprising:
a memory device with computer-readable program code stored thereon;
at least one processing device operatively coupled to the at least one memory device and the at least one communication device, wherein executing the computer-readable code is configured to cause the at least one processing device to:
receive a set of file extensions associated with an error generated from an at least one piece of software,
wherein the set of file extensions comprises a record of events and actions from the at least one piece of software;
analyze the set of file extensions using an advanced computation model for data analysis and automated decision-making;
determine a set of root cause analysis from the analyzed set of file extensions using a root cause database,
wherein the root cause database is comprised of previously encountered file extensions and associated root cause analyses;
summarize the set of root cause analysis using the advanced computation model for data analysis and automated decision-making and a predetermined database of identifiers; and
transmit the summarized set of root cause analysis associated with the error generated from the at least one piece of software to an end-point device.

2. The system of claim 1, wherein analysis of the set of file extensions using advanced computation models for data analysis and automated decision-making comprises searching a secondary set of file extensions associated with the generated error.

3. The system of claim 1, wherein summarizing the set of root cause analysis using the advanced computation model for data analysis and automated decision-making and a predetermined database of identifiers comprises forming the summary of the set of root cause analysis using terms found within the database of identifiers.

4. The system of claim 1, wherein determination of the root cause analysis comprises:
transfer the set of file extensions to an external source;
determine the set of root cause analysis using the external source; and
store the set of root cause analysis and associated set of file extensions within the root cause database.

5. The system of claim 1, wherein transmission of the summarized set of root cause analysis associated with the error generated from the at least one piece of software comprises:
a notification identifying a root cause location within the at least one piece of software associated with the error generated within the at least one piece of software;
a notification defining the error generated within the at least one piece of software; and
a notification identifying the set of file extensions associated with the error generated from the at least one piece of software.

6. The system of claim 5, wherein the set of root cause analysis transmitted to the end-point device comprises:
a summary of a root cause of the error; and
a location of the error identified on the at least one piece of software.

7. The system of claim 5, wherein transmission of the summarized set of root cause analysis associated with the error generated from the at least one piece of software further comprises an input transmitted to the end-point device associated with the set of root cause analysis.

8. A computer program product for using advanced computation models for data analysis and automated decision-making for root cause analysis within software, the computer program product comprising at least one non-transitory computer-readable medium having computer-readable program code portions embodied therein, the computer-readable program code portions comprising:
an executable portion configured to receive a set of file extensions associated with an error generated from an at least one piece of software,
wherein the set of file extensions comprises a record of events and actions from the at least one piece of software;
an executable portion configured to analyze the set of file extensions using an advanced computation model for data analysis and automated decision-making;
an executable portion configured to determine a set of root cause analysis from the analyzed set of file extensions using a root cause database,
wherein the root cause database is comprised of previously encountered file extensions and associated root cause analyses;
an executable portion configured to summarize the set of root cause analysis using the advanced computation model for data analysis and automated decision-making and a predetermined database of identifiers; and
an executable portion configured to transmit the summarized set of root cause analysis associated with the error generated from the at least one piece of software to the end-point device.

9. The computer program product of claim 8, wherein analysis of the set of file extensions using advanced computation models for data analysis and automated decision-making comprises searching a secondary set of file extensions associated with the generated error.

10. The computer program product of claim 8, wherein summarizing the set of root cause analysis using the advanced computation model for data analysis and automated decision-making and a predetermined database of identifiers comprises forming the summary of the set of root cause analysis using terms found within the database of identifiers.

11. The computer program product of claim 8, wherein determination of the root cause analysis comprises:
transfer the set of file extensions to an external source;
determine the root cause analysis using the external source; and
store the root cause analysis and associated set of file extensions within the root cause database.

12. The computer program product of claim 8, wherein transmitting the summarized set of root cause analysis associated with the error generated from the at least one piece of software comprises:
a notification identifying a root cause location within the at least one piece of software associated with the error generated within the at least one piece of software;
a notification defining the error generated within the at least one piece of software; and
a notification identifying the set of file extensions associated with the error generated from the at least one piece of software.

13. The computer program product of claim 12, wherein the set of root cause analysis transmitted to the end-point device comprises:
a summary of a root cause of the error; and
a location of the error identified on the at least one piece of software.

14. The computer program product of claim 12, wherein transmission of the summarized set of root cause analysis associated with the error generated from the at least one piece of software further comprises an input transmitted to the end-point device associated with the set of root cause analysis.

15. A method for using advanced computation models for data analysis and automated decision-making for root cause analysis within software, the method comprising:
receiving a set of file extensions associated with an error generated from an at least one piece of software,
wherein the set of file extensions comprises a record of events and actions from the at least one piece of software;
analyzing the set of file extensions using an advanced computation model for data analysis and automated decision-making;
determining a set of root cause analysis from the analyzed set of file extensions using a root cause database,
wherein the root cause database is comprised of previously encountered file extensions and associated root cause analyses;
summarizing the set of root cause analysis using the advanced computation model for data analysis and automated decision-making and a predetermined database of identifiers; and
transmitting the summarized set of root cause analysis associated with the error generated from the at least one piece of software to the end-point device.

16. The method of claim 15, wherein analyzing the set of file extensions using advanced computation models for data analysis and automated decision-making comprises searching a secondary set of file extensions associated with the generated error.

17. The method of claim 15, wherein summarizing the set of root cause analysis using the advanced computation model for data analysis and automated decision-making and a predetermined database of identifiers comprises forming the summary of the set of root cause analysis using terms found within the database of identifiers.

18. The method of claim 15, wherein determining of the root cause analysis comprises:
transferring the set of file extensions to an external source;
determining the root cause analysis using the external source; and
storing the root cause analysis and associated set of file extensions within the root cause database.

19. The method of claim 15, wherein transmitting the summarized set of root cause analysis associated with the error generated from the at least one piece of software comprises:
a notification identifying a root cause location within the at least one piece of software associated with the error generated within the at least one piece of software;
a notification defining the error generated within the at least one piece of software; and
a notification identifying the set of file extensions associated with the error generated from the at least one piece of software.

20. The method of claim 19, wherein transmitting the summarized set of root cause analysis associated with the error generated from the at least on piece of software further comprises an input transmitted to the end-point device associated with the set of root cause analysis.
